(19) United States
(12) Patent Application Publication
(10) Pub. No.: US 2012/0045105 A1
(43) Pub. Date: Feb. 23, 2012

(54) METHOD AND DEVICE TO PROVIDE QUALITY INFORMATION FOR AN X-RAY IMAGING PROCEDURE

(76) Inventors: Klaus Engel, Nuernberg (DE); Oliver Klar, Nuernberg (DE); Markus Kowarschik, Langenzenn (DE); Manuel Meilinger, Regensburg (DE); Holger Scherl, Erlangen (DE); Christian Schmidgunst, Erlangen (DE)

(21) Appl. No.: 13/210,606

(22) Filed: Aug. 16, 2011

(30) Foreign Application Priority Data
Aug. 20, 2010 (DE) 10 2010 034 918.6

(51) Int. Cl. G06K 9/00

(52) U.S. Cl. 382/131

(57) ABSTRACT

In a method and device spatially resolved quality information is provided for an x-ray imaging procedure in which a data field representing the examination subject is reconstructed from a number of exposures of an examination subject. Quality information that indicates the reliability of the reconstructed data field for the corresponding element is determined for a number of elements of the data field.

### BACKGROUND OF THE INVENTION

1. Field of the Invention

The invention concerns the field of x-ray imaging. In particular, the invention concerns methods and devices that can be used in an x-ray imaging procedure in which a data field representing the examination subject, such as a set of 3D volume data, is reconstructed from a number of exposures.

2. Description of the Prior Art

Three-dimensional image or subject acquisition is widespread in medical technology. 3D volume data frequently serve for the preparation of therapeutic and/or surgical measures. One example of an application is trauma reconstruction (for example to treat bone fractures) in which additional treatment steps can be planned using previously acquired 3D volume data of the examination subject.

Methods and devices for 3D x-ray imaging are known with which 3D volume data of the examination subject can be reconstructed. Exemplary methods include computed tomography or cone beam computed tomography, without being limited to these. In 3D x-ray imaging, metal objects or other objects with a strong x-ray absorption can disadvantageously affect the reconstructed data. A metal object can lead to a degradation of the image quality and the reconstructed volume data. For example, image disturbances known as metal artifacts can occur. Depending on the position of the metal object, the information about the irradiated tissue can be affected (i.e. distorted or even obliterated) with different degrees of severity in different acquired images. This can lead to the situation that portions of the examination subject near metal objects, as well as portions that lie farther removed from the metal object, cannot be completely scanned (i.e., a complete image data set cannot be obtained). How severely the individual segments of the examination subject are affected by such effects depends on a number of factors. For example, the beam geometry, the geometry of the metal object and the attitude of the beam geometry relative to the geometry of the metal subject play a role in the acquisition of the different images.

Various approaches can be taken for the correction of metal artifacts. For example, regions in projection exposures can be substituted, i.e. artificially filled. For this an interpolation between the actual acquired data can be used that is as physically compatible as possible. However, such computationally determined data are less reliable for the reconstruction than data that are not negatively affected by metal shadows and thus can be directly used for the reconstruction.

From DE 10 2008 050 570 A1 a method is known with which a 3D image data set of a body is generated that contains an object that is impermeable to x-ray radiation.

In other methods an interpolation or extrapolation of actual acquired data can also be used in order to subsequently generate a reconstruction result via filtered back-projection. Examples of such a generation of synthetic data include techniques known as extended field of view methods, in which a sinogram expansion around synthetic data can take place in advance.

The user of a device for x-ray imaging conventionally does not receive any information about the effect of metal objects or synthetic data on the reconstructed 3D volume data or on a reconstructed 2D slice image. Since the influence of a metal object or synthetic data on reconstructed volume data depends on a number of factors and varies spatially, it can be difficult for a user to estimate this influence. This also applies when a 2D slice image is reconstructed from a number of one-dimensional exposures.

### SUMMARY OF THE INVENTION

An object of the present invention is to provide a method and a device that can provide information to a viewer of an x-ray image about the influence of metal objects or other strongly absorbing objects in the image, or information about the influence of synthetic data on the quality of a reconstructed data field.

According to one aspect of the invention, a method provides spatially resolved quality information for an x-ray imaging in which a two-dimensional or three-dimensional data field representing the examination subject is reconstructed from a number of exposures of an examination subject. Quality information that indicates the reliability of the data field (reconstructed from the number of exposures) for the corresponding element of the data field is thereby determined for a number of elements of said data field. The quality information thus quantifies the quality or reliability of the reconstruction result with spatial dependence.

Additional information (in addition to the reconstructed data field) is provided to the user via the quality information that indicates the reliability of a reconstruction result with spatial resolution.

The quality information, moreover, can be used in the visualization of the reconstruction result.

In an embodiment of the method, the quality information for the number of elements of the data field can be determined depending on in how many of the exposures used for reconstruction of a metal shadowing of the corresponding element (voxel, for example) exist. Information about the spatially dependent influence of the metal shadow thus can be generated.

In an embodiment of the method, the quality information for the number of elements of the data field can be determined depending on the number of exposures, among the exposures used for reconstruction, in which the corresponding element (voxel, for example) was reconstructed from synthetic data. As used herein, synthetic data are data that are not directly acquired from the subject by a data acquisition. Examples of such synthetic data are image regions that are determined by interpolation or extrapolation of acquired data.

In a further embodiment of the method a segmentation of the exposure can be implemented for each exposure in the number of exposures, in order to determine exposure regions in which projection lines end, that have traversed a partial volume of the examination subject with a predetermined property associated with the acquisition of the respective exposures (such as a partial volume with an absorption coefficient exceeding a threshold). For a number of elements of the data field, the quality information can be determined depending on whether the corresponding element of the data field was respectively imaged in the exposure region determined for exposure by the segmentation in the acquisition of that exposure. This means that the quality information can be determined depending on, for example, whether in the data acquisition a voxel of reconstructed 3D volume data or a pixel of a reconstructed 2D slice image was positioned at a projection ray that ends at a pixel of the respective exposure, the pixel being within the exposure region determined by segmentation. The exposure region determined by segmentation can be a region in which a metal shadow is present. The exposure region determined by segmentation can be a region in which synthetic data are used for reconstruction, such synthetic data being determined computationally from the acquired data, for example via interpolation or extrapolation.

With the method according to the exemplary embodiment, for elements of the data field (for example voxels of 3D volume data), the spatially resolved quality information is determined depending on whether, in the acquisition of the different exposures, those elements are positioned on a projection line that runs through the partial volume (for example a metal object). The term “projection line” means a line along which x-ray radiation propagation from an x-ray source to a pixel of an x-ray detector in the acquisition of the exposure. The term does not necessarily mean that a measurable x-ray intensity must have been present at the corresponding voxel during the respective acquisition. In this way it can be determined for the number of elements of the data field whether, in the acquisition of the various exposures from which the data field is reconstructed, the shadowing (by a metal object, for example) could lead to the situation that information concerning the corresponding element of the data field was significantly attenuated or obliterated.

The exposures can be one-dimensional or two-dimensional exposures that are acquired with a device for x-ray imaging, for example a computed tomography system.

In embodiments, the data field represents reconstructed 3D volume data, wherein the elements of the data field represent voxels of the volume data. The exposures from which the 3D volume data are reconstructed can be 1D or 2D exposures. In further embodiments, the data field represents 2D image data (for example a slice image of the examination subject) that are reconstructed from a number of line exposures.

The partial value can in particular be a metal object.

The quality information can be determined for all elements of the data field. This means that, for example, the voxel resolution in the determination of the quality information can be the same as the voxel resolution in the reconstruction of 3D volume data.

The determined quality information can be provided to a user (viewer). The quality information can be merged with the reconstructed data field for an output. The quality information can be used in order to affect a presentation of the reconstructed data field at a display unit. The quality information can also be stored for a later use as a data set.

To determine the quality information, for each element of the number of elements of the data field it can be determined in how many exposures the corresponding element was imaged in the exposure region determined for the exposure. The exposure region can be a region in which significant metal shadowing is present and/or a region filled with synthetic data. It is thereby taken into account that the quality of reconstructed data can decrease when the information pertaining to an element of the data field was attenuated or obliterated in a larger number of exposures in that the projection line running through the element passed through a metal object.

For each element of the number of elements of the data field, a parameter (dimensionless number) can be determined that is proportional to a count of the exposures in which the corresponding element was imaged in the determined exposure region. The quality information for the corresponding element can be determined based on this parameter. In one embodiment, for the number of elements of the data field, a value that is equal to the number of exposures in which the corresponding element was imaged in the determined exposure region is respectively assigned to the quality information for each element. In a further embodiment, for the number of elements of the data field, a value that is equal to the number of exposures in which the corresponding element was imaged in the determined exposure region, divided by the total number of exposures, is respectively assigned to the quality information for each element. The quality information is normalized in this way. In a further embodiment, the quality information for each element can be respectively determined in that the number of exposures in which the corresponding element was imaged in the determined exposure region is subtracted from the total number of exposures. In a further embodiment, the last cited variable for normalization can be divided by the total number of exposures.

In order to determine the quality information, for each exposure of the number of exposures, an associated, modified exposure can be determined depending on the exposure region determined for said exposure. A back-projection of the modified exposures can be made in order to determine the quality information for the number of elements of the data field. The back-projection can take place in a known manner. For example, for each voxel of the subject, it can be determined which pixel of the exposure elements of the data field was imaged by that voxel given the relative arrangement of beam path and examination subject that was present for the image acquisition. The value of the quality information for the element of the data field is increased by the value of the pixel in the modified image. The process is iteratively repeated for all images. The simplified reconstruction resulting by unfiltered back-projection from the modified exposures provides a spatially resolved quality information. A normalization or other suitable scaling of the simplified reconstruction can be conducted. The generation of the modified exposures allows the modified exposures to be used as input data of a reconstruction procedure, wherein the information about the attitude of the imaged volume relative to x-ray source and detector (which information is required for the reconstruction of the data field) can be used.

The modified exposures can be generated as binary exposures. Each of the modified exposures thus can be determined so that a first value (1, for example) is assigned to a pixel of the modified exposure when the pixel coordinates lie within the exposure region determined by segmentation, and that otherwise a second value (0, for example) differing from the first value is assigned to a pixel of the modified exposure. This allows the spatially resolved quality information to be obtained with computationally efficient methods, for example by back-projection of the modified exposures.

The segmentation of the exposures can take place using a threshold comparison. Exposure regions at which beams are strongly attenuated after traversing a metal object can thereby be detected. In the event that the quality information is determined depending on in how many exposures a back-projection of synthetic data takes place in order to reconstruct a voxel, the knowledge about the regions filled with synthetic data provides a natural segmentation.

The data field can be reconstructed from the number of exposures. A presentation of the data field—for example via an optical display device—can be generated depending on the spatially resolved quality information. Information about the reliability of the reconstructed 3D volume data can thereby be output to the user, for example simultaneously with said reconstructed 3D volume data. The presentation of the 3D volume data does not need to include the simultaneous presentation of all 3D volume data; rather, this can take place through the calculation and presentation of a slice or multiple slices, for example.

The presentation of the data field depending on the spatially resolved quality information can take place via a color coding depending on said quality information, For example, for this purpose a color coding that represents the quality information can be overlaid on the value of elements of the data field (which value is presented in a greyscale). An intuitive color palette can be used for coding, for example in which red corresponds to an unreliable region, green to a region that has a high degree of reliability. Alternatively or additionally, elements of the data field are masked (hidden) in the presentation depending on the quality information associated with them.

Additional types for use of the quality information can be used in the presentation of the reconstructed data, in which types at least one of the following variables is affected depending on the spatially resolved quality information: color, transparency, blurriness, noise, texture. Alternatively or additionally, additional techniques can be used for visualization of the reliability, for example based on one or more of: shape, glyphs, deformation, displacement.

To generate the presentation of the data field, the quality information can be checked according to a predetermined criterion for the number of elements of the data field. For example, a comparison with reference values can take place in order to determine whether and how a color coding should take place or, respectively, whether the corresponding element should be masked. The reference values can be fixed. In further embodiments a user-defined establishment of the reference values can be provided. The severity with which the shadowing by a metal object affects the reliability of the reconstructed data field can be visualized in this way according to fixed or user-defined, predetermined criteria. The testing of the quality information can include a comparison with multiple reference values. For example, elements of the data field for which a shadowing by a metal object is present in at least a first portion (for example in at least 95%) of all exposures used for reconstruction can be presented in a first manner. Elements of the data field for which a shadowing by a metal object is present in at least a second portion (for example in at least 5%) of all exposures used for reconstruction can be presented in a second manner.

The number of exposures can be acquired with a line detector or area detector of a computer tomograph. The detector can be coupled with an electronic computer that automatically implements the method according to the embodiments.

The invention also encompasses a non-transitory computer-readable storage medium encoded with a command sequence (programming instructions) that cause a computer, in which the storage medium is loaded, to implement the method according to one or more embodiments. For example, the computer program can be loaded into the memory of a control and evaluation computer of a device for x-ray imaging (a computed tomography, for example). The computer program can exist as source code or as a compiled command sequence. Via the computer program the device can be programmatically configured to implement the method. The data storage medium can be a CD-ROM, a DVD, a magnetic tape, a flash memory or a USB stick or another non-volatile data medium on which the command sequence is stored as electronically readable control information.

The invention also encompasses a device to provide spatially-resolved quality information for an x-ray imaging. The device includes an electronic computer that is configured to receive a number of exposures of an examination subject from which a 2D or 3D data field representing the examination subject can be reconstructed. The computer is configured in order to respectively determine a quality information for a number of elements of the data field, this quality information indicating the reliability of the data field reconstructed from the number of exposures for the corresponding element of the data field.

The computer allows information about the quality of a reconstruction result to be provided with spatial resolution.

The computer can be configured in order to use the quality information in the visualization of the reconstruction result, i.e. of the reconstructed data field.

The computer can determine the quality information for each of the number of elements of the data depend depending on the number of the exposures, among the exposures, used for reconstruction, a metal shadowing of the corresponding element exists. Information about the spatially dependent influence of the metal shadow can thereby be generated.

The computer can determine the quality information for each of the number of elements of the data depending on the number the exposures, among the exposures used for reconstruction, the corresponding element was back-projected from synthetic data.

The computer can be configured in order to implement a segmentation of the exposure for each exposure of the number of exposures. Through the segmentation, exposure regions are determined in which projection lines end, which traverse a partial volume of the examination subject with predetermined properties associated with the acquisition of the respective exposure (in particular a partial volume with an absorption coefficient exceeding a threshold). The computer can also be configured in order to determine the quality information for a number of elements of the data field depending on whether the corresponding element was respectively imaged in the acquisition region determined for the acquisition during the acquisition of that exposure.

The device can determine a spatially resolved quality information for elements of the data field depending on whether they are positioned on a projection line that passes through the absorbing partial volume during the acquisition of the various exposures. In this way, for the number of elements of the data field it can be determined whether the shadowing (for example by a metal object) could lead to the situation that information pertaining to the element of the data field was significantly attenuated or obliterated in the acquisition of the different images from which the data field is reconstructed.

The computer can be configured in order to reconstruct the data field from the number of images. The device can include an optical output device coupled with the computer, and the computer can be configured in order to control the optical output device depending on the spatially resolved quality information to output the data field. Information about the reliability of reconstructed 2D or 3D data thus can be provided as an output to the user simultaneously with said reconstructed 2D or 3D data.

The device can be configured to implement the method according to any of the embodiments.

The invention also encompasses a computer tomography system that includes a line detector or an area detector to acquire exposures of the examination subject, and a device coupled with the detector as described above to provide quality information according to any of the described embodiments.

Embodiments of the invention are suitable in order to provide spatially resolved information about the influence of shadows in reconstructed 2D image data or 3D volume data to a user. Fields of application are, for example, present in medical technology.

### BRIEF DESCRIPTION OF THE DRAWINGS

FIG. 1 is a schematic presentation of a computed tomography with a device according to an exemplary embodiment of the invention.

FIG. 2 is a schematic representation of a segment of an examination subject that is represented by 3D volume data, and of acquired images.

FIG. 3 is a schematic representation of multiple acquired images to explain the method of the invention according to an exemplary embodiment.

FIG. 4 is a schematic representation of multiple modified images to explain the method of the invention according to an exemplary embodiment.

FIG. 5 is a flowchart of the method of the invention according to an exemplary embodiment.

FIG. 6 illustrates the presentation of 3D volume data depending on spatially resolved quality information.

### DESCRIPTION OF THE PREFERRED EMBODIMENTS

The features of the exemplary embodiments described in the following can be combined with one another insofar as this is not expressly indicated otherwise.

In the following exemplary embodiments of the invention are described in the context of an x-ray imaging in which 2D images are acquired and 3D volume data are reconstructed from these. However, the method and devices according to exemplary embodiments of the invention can likewise be applied to other fields. For example, the methods and devices can be applied when 3D volume data are reconstructed from multiple 1D exposures. The methods and devices can also be applied when 2D image data are reconstructed from multiple 1D exposures.

In the following exemplary embodiments are described in the context of an application in which the influence of a metal shadow on a reconstructed data field is quantified by the quality information. However, the exemplary embodiments are not limited to this application but rather can be used in additional applications. For example, the exemplary embodiments can be used in order to quantify the contribution of synthetic data (for example data determined via interpolation or extrapolation) to a reconstructed voxel.

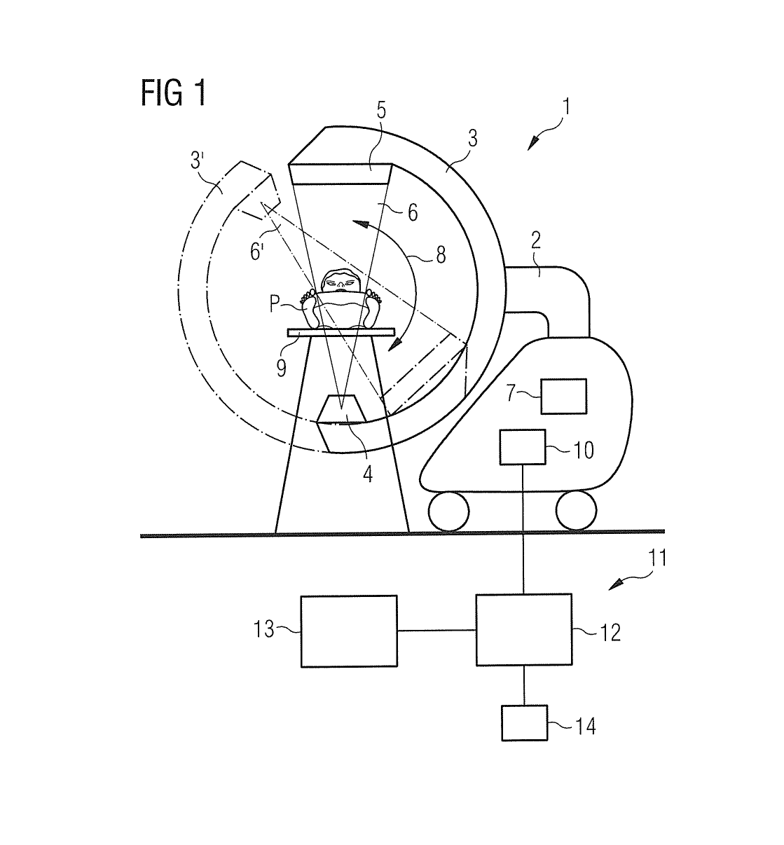

FIG. 1 is a schematic representation of a computed tomography system 1 with a device to provide spatially resolved quality information according to one exemplary embodiment. The computed tomography system 1 includes a device 2 for image acquisition and a device 11 that provides spatially resolved quality information. The device 2 includes an x-ray source 4 and a detector 5 to acquire x-ray radiation after traversal of an examination subject P that is supported by a table 9. The device 2 can have various embodiments. For example, the computed tomography system can be designed as a cone beam computed tomography system or as a conventional computed tomography system. Other embodiments of the device 2 for image acquisition are also possible. Shown as an example in FIG. 1 is an embodiment in which the x-ray source 4 and the detector 5 are attached to a C-arm 3. For example, the detector 5 can be designed as a line detector or as an area detector. A drive device 7 is provided in order to reposition the x-ray source 4 and the detector 5 relative to the table 9 with the examination subject P. A movement around an axis perpendicular to the plane of the drawing of FIG. 1 is schematically represented at 8. An additional position of the C-arm with x-ray source and detector is shown with dashed lines at 3′. An additional drive device can be provided in order to displace the table 9 in a translational manner relative to the C-arm 3. A control device 10 controls the x-ray source 4, the detector 5 and the drive device 7. The x-ray source 4 and the detector 5 are positioned in a number of different positions relative to the examination subject P. A data acquisition in which an image is acquired takes place in each of the positions.

The device 11 includes a computer 12, a display device 13 and a memory 14. In the computer tomograph 1 the computer 12 not only determines spatially resolved information but rather simultaneously operates as an evaluation computer that reconstructs 3D volume data of the examination subject from the number of acquired images. According to embodiments of the invention, the computer 12 is configured to determine a spatially resolved quality information for the reconstructed 3D volume data and provides this to a user. The user is thereby informed of how severely individual segments of the reconstructed 3D volume data are negatively affected in terms of their reliability, in that x-rays on their path from the x-ray source 4 to the detector 5 have traversed a partial volume of the examination subject P with high absorption coefficients for x-ray radiation. For this purpose, for multiple voxels (in particular for every voxel) of the 3D volume data the computer 12 can determine a parameter that represents the quality information or from which the quality information can be derived. In one embodiment, for multiple voxels of the 3D volume data the computer 12 determines in how many of the data acquisitions the corresponding voxel was positioned on a projection line that has also passed through a partial volume of the examination subject P with high absorption coefficient (in particular through a metal). For this the computer 12 can implement one of the methods described herein. Command code that induces the computer to automatically implement the method can be stored in the memory 14.

The computer 12 can provide the determined, spatially resolved quality into to a user. In one embodiment, to optically output the 3D volume data the display device 13 can be controlled not only dependent on the 3D volume data to be displayed but also dependent on the determined quality information. For example, to show a slice through the reconstructed volume a slice through the 3D volume data can be presented at the display device 13, wherein the presentation is affected depending on the quality information for the corresponding voxels. In one embodiment, the quality information can be superimposed in a color scale on the slice through the 3D volume data. Alternatively or additionally, voxels of the 3D volume data can be selectively masked depending on the quality information associated with them.

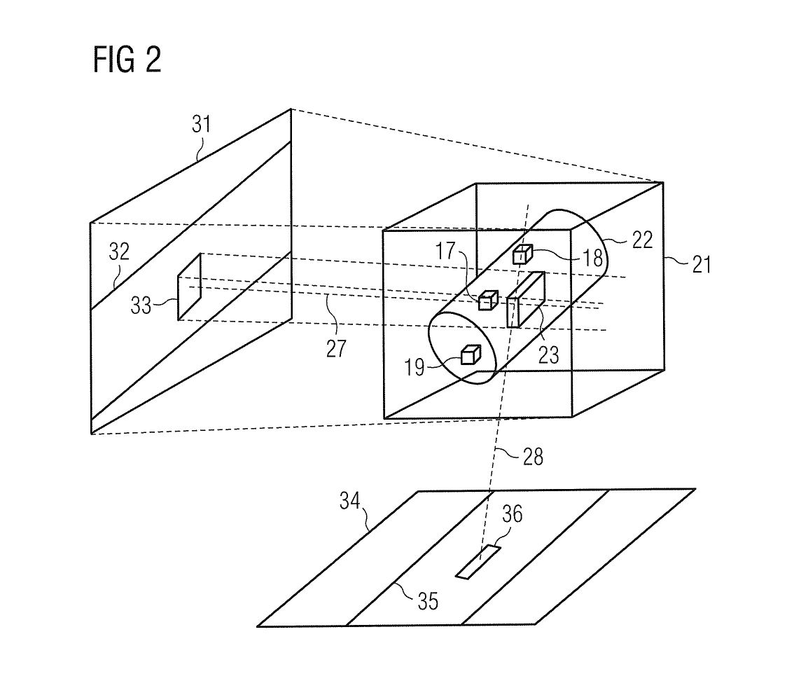

According to one embodiment, the determination of the spatially dependent quality information is described in detail using an exemplary examination subject with reference to FIG. 2-4. The described segments can be implemented by the computer 12.

FIG. 2 is a schematic representation of a volume 21 with an examination subject 22. Multiple images 31, 34 of the volume 21 with the examination subject 22 (for example an arm or leg) are acquired. The images represent exposures of the examination subject. The attitude of the beams used for data acquisition relative to the volume 21 is different for different images. The projection can be described well by projection matrices that are known for the different data acquisitions and can be used for reconstruction.

The examination subject 22 has a metal object 23 that forms a partial volume with a high absorption coefficient for x-ray radiation. The partial volume 23 can be a metal object, for example. In medical imaging such objects can be present on or in a patient (on whom a data acquisition is conducted with a computer tomograph) in the form of screws, pins, plates or other implants made of metal. Metal objects can also be present that were not intentionally introduced into the patient, for example metal splinters that are introduced into the patient after an accident. The absorption by the metal object 23 can led to a spatially variable influence of metal shadows.

According to one embodiment, for each voxel of the 3D volume data it can be determined whether, in the acquisition of the various images 31, 34, the corresponding voxel was located on a projection line that has passed through the metal object 23, such that the x-ray radiation has experienced a significant attenuation. In one embodiment it can be determined for each voxel of the 3D volume data whether, in the acquisition of the various images 31, 34, the corresponding voxel was located on a projection line along which the x-ray radiation was so strongly attenuated that the signal intensity detected at the corresponding pixels of the image 31, 34 is less than a threshold. The number of images in which, during the image data acquisition, a voxel of the 3D volume data was positioned on a projection line along which the x-ray radiation was strongly attenuated, can be used as the quality information for the voxels, or the quality information can be determined depending on the number of these images.

The acquired images 31, 34 can be segmented to determine the quality information. The image 31 has a map 32 of the examination subject 22. An image region 33 of the image 31 in which the metal object 23 is imaged in the data acquisition can be determined via segmentation. The image region 33 represents an exposure region of a 2D exposure that is determined via segmentation. The image 34 has a map 35 of the examination subject 22. An image region 36 of the image 34 in which the metal object 23 is imaged can be determined via segmentation. The image region 36 represents an exposure region of a 2D exposure that is determined via segmentation. The segmentation can take place in various ways. For example, a threshold comparison the signal intensity can be used. Other procedures for metal segmentation can be used. Those image regions 33, 36 in which the acquired signal intensity is less than a threshold can thereby be segmented in the images 31, 34. To determine the quality information, for each voxel of the 3D volume data it can be determined whether, in the acquisition of the various images 31, 14, the corresponding voxel was respectively imaged in a pixel that is comprised by the image region determined via segmentation. In the event that the influence of synthetic data should be quantified with spatial resolution with the quality information, the exposure region can also be defined as the region filled with synthetic data, the boundaries of which are known.

Exemplary voxels 17-19 of the reconstructed volume data are shown in FIG. 2. In the acquisition of the image 31 the voxel 17 is imaged in a pixel of the image 31 that is comprised by the image region 33 determined via the segmentation. The projection line 27 through the voxel 17 also passes through the metal object 23. The attenuation of the x-ray radiation leads to a reduction of the information content about the voxel 17 in the image 31. In the acquisition of the image 34 the voxel 17 is not imaged in the image region 26 determined via segmentation. In acquisition of the image 34 the voxel 18 is imaged in a pixel that lies within the image region 33 determined via segmentation. The projection line 28 through the voxel 18 also runs through the metal object 23. In the acquisition of the image 31 the voxel 18 is not imaged in the image region 33 determined via segmentation. Neither in the acquisition of the image 31 nor in the acquisition of the image 34 is the voxel 19 imaged in the respective image region 33, 36 determined via segmentation.

According to embodiments of the invention, the number of images in whose acquisition different voxels were respectively positioned on a projection line along which a beam had experienced an attenuation exceeding a threshold can be determined by the acquired images being initially segmented, with modified images are subsequently being generated and an unfiltered back-projection of the modified images being implemented. With the segmentation, the image region in which the metal object was imaged can be determined for each of the images. Depending on the determined image region, a modified image (that can be a binary image) can be generated for each of the images. A first value (1, for example) can be assigned to pixels that are comprised by the determined image region. A second value (0, for example) can be assigned to pixels that are not comprised by the determined image region. By back-projection of the modified images, a 3D data field is generated that is also designated as a simplified 3D reconstruction in the following. For the voxels of the 3D volume data the values of this data field respectively represent the number of images in whose acquisition the corresponding voxel lay on a projection line that runs through the metal object and thereby was significantly attenuated.

According to embodiments of the invention, the number of images that provide synthetically generated data for the reconstruction of a voxel can be determined in a similar manner. The regions with synthetic data define a segmentation, wherein modified binary images can subsequently be generated and a back-projection of the modified images can be implemented.

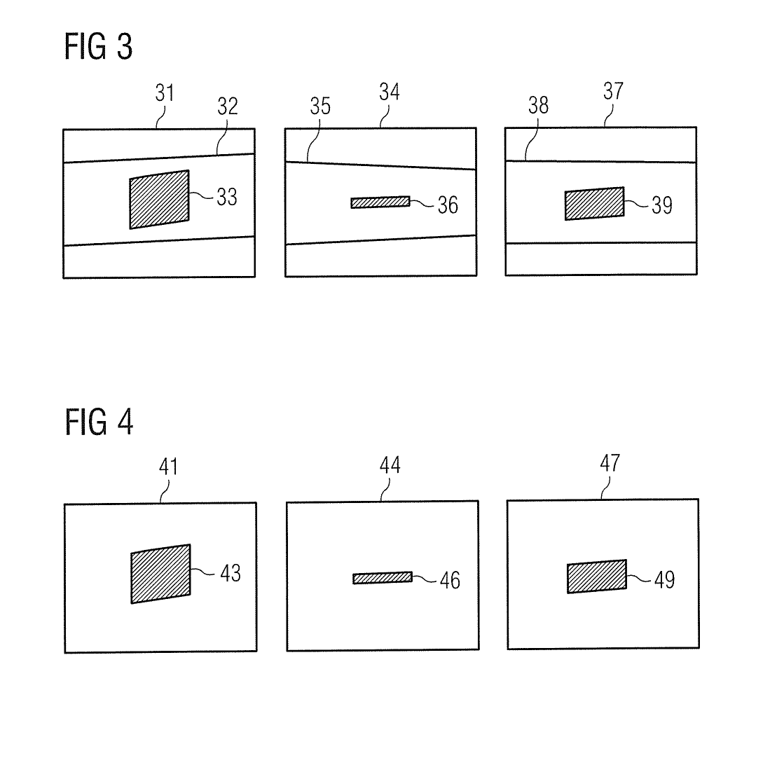

FIG. 3 schematically shows acquired images 31, 34 and 37. The image 31 has the map 32 of the examination subject. An image region 33 in which the metal object is imaged is determined via segmentation. The image 34 has the map 35 of the examination subject. An image region 36 in which the metal object is imaged is determined via segmentation. The image 37 has the map 38 of the examination subject. An image region 39 in which the metal object is imaged is determined via segmentation.

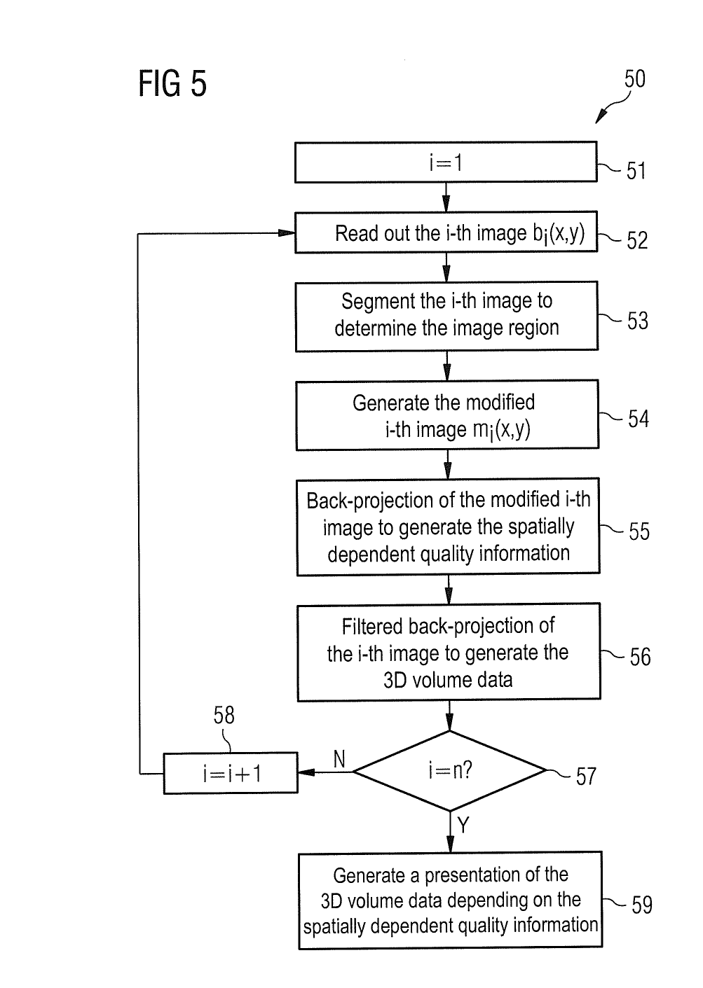

FIG. 4 shows modified images 41, 44 and 47 that are associated with the images 31, 34 and 37. The image 41 is generated as a binary image so that pixels in the image region 43 that was determined via segmentation have a first value, and otherwise have a second value that is different than the first value. The image 44 is similarly generated as a binary image so that pixels in the image region 46 that was determined by segmentation have a first value, and otherwise have a second value that is different than the first value. The image 47 is generated as a binary image so that pixels in the image region 49 that was determined via segmentation have a first value, and otherwise have a second value that is different than the first value. The first value can be 1 and the second value can be 0.

The simplified 3D reconstruction, which can be used as a spatially resolved quality information or on the basis of which the spatially resolved quality information can be determined via additional operations, is generated via back-projection of the modified images 41, 44 and 47.

Correspondingly, in the reconstruction of a 2D slice image of the examination subject from multiple 1D exposures a segmentation can be implemented for each of the 1D exposures, and a binary exposure can be generated depending on this. By unfiltered back-projection of the binary exposures a simplified 2D reconstruction results in which the value of the different elements of the simplified 2D reconstruction indicates in how many exposures the corresponding element was positioned on a projection beam that was attenuated by a metal object.

FIG. 5 is a flowchart of a method 50 to provide spatially resolved quality information according to one exemplary embodiment. The method can be implemented by the computer 12.

At 51 a loop is initialized across [sic?] the images from which 3D volume data are reconstructed.

The i-th image is read out at 52. The image can be queried immediately after its acquisition by an x-ray detector. Steps 53-56 can then be implemented in parallel for the acquisition of additional images. The image is a 1D or 2D data field. In the event that the x-ray detector is an area detector, the image is a 2D data field bᵢ(x, y), wherein i is an image index, x and y is a coordinate double for pixel coordinates and bᵢ(x, y), is a value associated with this pixel, which value can (for example) represent the detected signal intensity.

The i-th image is segmented at 53 in order to determine an image region in the i-th image in which beams were acquired that have passed through a metal object or another object with strong x-ray absorption. In one embodiment, the segmentation can be implemented based on a threshold comparison. More complex metal segmentation can likewise be used. Depending on the examination subject and beam geometry, an image region that is segmented as metal does not necessary need to exist. In the event that the influence of synthetic data should be quantified with the quality information, the image region filled with synthetic data can define a natural segmentation.

At 54 a modified image is generated depending on the image region determined at 53. The modified image can be a binary image mᵢ(x, y). For example, the modified image can be generated as a black-and-white image in which

$${m}_{i} ( x , y ) = \{ \begin{matrix}1 , & if ( x , y ) ∈ image region of the i \text{-} th image , \\ 0 & otherwise .\end{matrix} \qquad ( 1 )$$

In other embodiments, different values can be associated with the determined image region and the image region that is complementary to this.

A back-projection of the modified image takes place at 55. The modified i-th image can thereby be used as input data for a conventional reconstruction algorithm. The image is advantageously not filtered before the back-projection is implemented. In the back-projection it can be determined per voxel in which pixel (r, s) of the i-th image the corresponding voxel was imaged. In x-ray imaging the mapping between voxel and pixel in the respective data acquisitions can, for example, be determined on the basis of projection matrices. The attitude of x-ray source and detector relative to the imaged volume in the respective data acquisition enters into the via the projection matrices. The corresponding value mᵢ(r, s) of the modified pixel is added to the value of the voxel. In this way the value of the voxel is increased by a predetermined value (by 1, for example) in the event that the voxel was imaged in a pixel that is encompassed by the image region determined by segmentation. Otherwise the value of the voxel remains unchanged. Through these operations in the various iterations, a 3D data field g(x, y, z) is generated that is subsequently also designated as a simplified 3D reconstruction. The same voxel resolution (i.e. the same number of voxels) can be used for the back-projection at 55 as is used in the filtered back-projection of the image data to reconstruct the 3D volume data.

A filtered back-projection of the acquired image can be implemented at 56, which represents an optional step. In addition to the determination of the quality information at 55, the conventional 3D reconstruction can thus also take place at 56.

At 57 it is checked whether the last image with the index n (which is equal to the total number of images) has already been reached. In the event that the last image has not yet been reached, the index i is incremented at 58. Steps 52-57 are repeated for the next image. In the event that all images from which the 3D volume data are reconstructed have been assessed, the method continues at 59.

At 59 the 3D volume data determined at 56 can be output to a user. The presentation is also generated depending on the spatially dependent quality information that can be obtained from the data field g(x, y, z) generated at 55 in the various iterations. The influence of metal shadows is visualized in this way.

The values of the data field g(x, y, z) indicate in how many of the images used to generate the 3D volume data a voxel with the coordinate triple (x, y, Z) was imaged in a pixel that is comprised by the image region determined via segmentation. This information can be directly used as spatially resolved quality information. In further embodiments, the spatially resolved quality information can be generated depending on the 3D data field g(x, y, z). For example, a normalization can take place such that (1/n)*g(x, y, z) is used as spatially resolved quality information. A lower value of this variable indicates that the reliability of the voxel is only slightly negatively affected by metal shadows or by the use of synthetically generated data. A value near 1 indicates that the reliability of the voxel can be strongly negatively affected by metal shadows or by the use of synthetically generated data since information content regarding the voxel was reduced or obliterated in a significant portion of the images, or only a small portion of the images offer directly acquired data as output data for the reconstruction. In further embodiments, the variable n−g(x, y, z) or the variable [n−g(x, y, z)]/n can be used as spatially resolved quality information.

The generation of the presentation of the 3D volume data depending on the spatially resolved quality information can take place in different ways. In one embodiment, regions of the 3D volume data are automatically marked in the presentation of said 3D volume data depending on the spatially resolved quality information. For example, segments that were identified with more certainty as metal or that are practically exclusively obtained via back-projection of synthetic data are presented in a first manner, for example with a first color. Segments in which (1/n)*g(x, y, z) is greater than an upper reference value (0.95, for example) can be presented in a second manner, for example with a second color. Segments in which (1/n)*g(x, y, z) is greater than a lower reference value (0.05, for example) and less than the upper reference value can be presented in a third manner, for example with a third color. Alternatively or additionally, color gradients can be superimposed on the 3D volume data, wherein the color gradients are generated depending on the spatially resolved quality information.

Alternatively or additionally, voxels of the 3D volume data can be shown or masked depending on the quality information associated with them. For example, in one embodiment voxels for which (1/n)*g(x, y, z) is greater than a reference value can be masked.

Numerous additional ways to fuse the reconstructed 3D volume data and the quality information can be used in the graphical output. For example, a visualization of the uncertainty via a technique can be used that is based on one or more of: color, transparency, blurriness, noise, texture, shape, glyphs, deformation, displacement etc.

In each of the cited variants for the generation of the presentation depending on the spatially resolved quality information, the manner of how the spatially resolved quality information is used for generation of the presentation can be influenced in a user-defined manner. For example, a user-defined determination of the cited reference values can be provided.

The presentation of the 3D volume data at 59 can take place via display of one or more slices, for example. The slice plane used for the presentation can be established as defined by the user. In further embodiments the 3D volume data can also be output so that they maintain depth information. For example, for this a stereoscopic optical display device can be used, wherein the output is in turn influenced depending on the spatially resolved quality information.

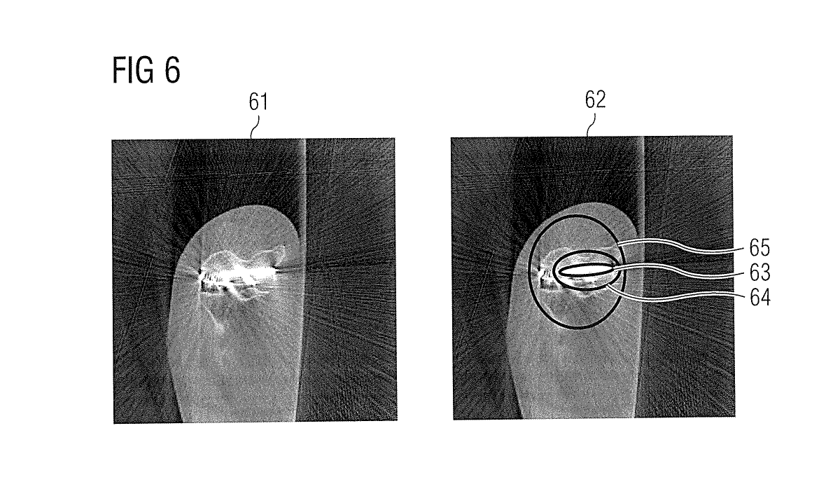

At 61 FIG. 6 shows 3D volume data of an arm with metal implant, wherein a section view of the reconstructed 3D volume data is presented. FIG. 6 furthermore shows a presentation 62 of the 3D volume data that is generated depending on spatially resolved quality information. Markings 63-65 in the form of lines are thereby superimposed on the section through the 3D volume data in the presentation 62. The line 63 is generated so that it marks a segment of the 3D volume data that was detected with certainty as metal. The line 64 is generated so that it marks a segment of the 3D volume data in which voxels in a number of images (that is greater than a first reference value) were arranged along a projection line that runs through the metal object. The line 65 is generated so that it marks a segment of the 3D volume data in which voxels in a number of images (that is greater than a second reference value) were arranged along a projection line that passes through the metal object.

Although exemplary embodiments have been described in detail with reference to Figures, modifications to these exemplary embodiments can be realized in further embodiments. Although exemplary embodiments have been described in the context of C-arm apparatuses, devices and methods according to embodiments of the invention can also be used in other apparatuses in which 3D volume data are reconstructed from 1D or 2D images. Although exemplary embodiments have been described in detail in which the spatially resolved quality information is determined for each voxel of the 3D volume data, in further exemplary embodiments the spatially resolved quality information can be determined only for a portion of the voxels of the 3D volume data. For example, it can be sufficient to determine and to output the quality information with a voxel resolution that is less fine than the voxel resolution that is used for the actual reconstruction of the 3D volume data. Although exemplary embodiments have been described in which the quality information is used in order to visualize the reliability of the reconstructed 3D volume data with spatial resolution, in further embodiments the determined quality information can also be used differently. For example, the quality information can be stored as a 3D data field for later use. Although exemplary embodiments have been described in the context of reconstruction of 3D volume data and 2D images, the methods and devices can also be used when 1D images are acquired and 3D volume data are reconstructed from these. Although exemplary embodiments have been described in the context of the reconstruction of 3D volume data from 2D images, the methods and devices can also be used when 1D images are acquired and 2D slice images should be reconstructed from these. Although exemplary embodiment have been described in which the spatially resolved quality information was determined only on the basis of the number of images given whose acquisition a voxel was arranged on a projection line passing through the metal object, additional factors can be taken into account in the determination of the quality information. For example, a weighting can take place. Images that show a more relevant view of the examination subject for a planned surgical or therapeutic procedure can enter into the determination of the quality information with a higher weighting than other images. Although exemplary embodiments have been described in the context of medal shadows, exemplary embodiments can also be used in order to indicate the influence of synthetically generated data with spatial resolution in the reconstruction.

The described methods and devices to determine and visualize a spatially resolved quality information can be combined with methods to reduce metal artifacts, for example with the method described in DE 10 2008 050 570 A1. After application of such a correction method, information about the influence of metal shadows can thus also be communicated to the user.

Exemplary embodiments of the invention allow the determination of visualization of spatially resolved quality information. Fields of application are, for example, in particular present in medical technology.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method to provide spatially resolved quality information for an x-ray imaging procedure in which a multi-dimensional data field representing an examination subject is reconstructed from a plurality of x-ray exposures of the examination subject, said method comprising the steps of:
providing said plurality of exposures to a computerized processor;
contemporaneously with reconstruction of said multi-dimensional data field, automatically analyzing, in said computerized processor, said plurality of exposures to determine quality information that indicates a reliability of said multi-dimensional data field for each of a plurality of picture elements in said data field; and
making said quality information available at an output of said computerized processor for viewing by a viewer contemporaneously with viewing the reconstructed multi-dimensional field.

2. A method as claimed in claim 1 comprising determining said quality information in said computerized processor by determining, for each picture element in said plurality of picture elements of the multi-dimensional data field, a number of exposures, among exposures used for reconstructing said multi-dimensional data field, in which metal shadowing or synthetic data were back-projected during reconstruction of said multi-dimensional data field.

3. A method as claimed in claim 1 comprising:
in said computerized processor, segmenting each exposure of said plurality of exposures to identify an exposure region in each exposure in which a projection line ends that has traversed a partial volume of the examination subject having a predetermined property associated with acquisition of the exposures; and
determining said quality information by identifying, for each picture element in said plurality of picture elements, that picture element was imaged in the respective exposure regions of the plurality of exposures.

4. A method as claimed in claim 2 comprising determining said partial volume as a partial volume in which all contents of the partial volume exhibit an absorption coefficient that exceeds a predetermined threshold.

5. A method as claimed in claim 3 comprising, for each picture element in said plurality of picture elements, determining said quality information as a number of exposures in which that picture element was positioned on said projection line that ends in one of said exposure regions.

6. A method as claimed in claim 3 comprising determining said quality criterion for each picture element in said plurality of picture elements as a parameter that is proportional to a count of exposures, in said plurality of exposures, in which that picture element was imaged in the respective exposure region.

7. A method as claimed in claim 3 comprising, for each exposure in said plurality of exposures, determining an associated, modified exposure dependent on the exposure region determined for that exposure.

8. A method as claimed in claim 7 comprising, in said computerized processor, implementing a back-projection of the respective modified exposures to determine said quality information for each picture element in said plurality of picture elements.

9. A method as claimed in claim 7 comprising generating each of said modified exposures as a binary exposure.

10. A method as claimed in claim 3 comprising segmenting said exposures using a threshold comparison of signal intensity in the respective exposures.

11. A method as claimed in claim 1 comprising displaying said multi-dimensional data field that is reconstructed from said plurality of exposures in a display presentation that is generated by said computerized processor dependent on said quality information.

12. A method as claimed in claim 11 comprising, in said computerized processor, checking said quality information with respect to a predetermined quality criterion to generate said presentation of said multi-dimensional data field.

13. A method as claimed in claim 1 comprising emitting said quality information in a presentation combined with the multi-dimensional data field reconstructed from said plurality of exposures, as a visual presentation.

14. A method as claimed in claim 1 comprising acquiring said plurality of exposures with a computed tomography system selected from the group consisting of a computed tomography system with a line detector and a computed tomography system with an area detector.

15. A method as claimed in claim 1 comprising acquiring said data field as a representation of three-dimensional volume data of the examination subject, with each picture element in the multi-dimensional data field representing a voxel of said three-dimensional volume data.

16. A non-transitory computer-readable storage medium encoded with programming instructions, said storage medium being loadable into a computer of an imaging system in which a plurality of exposures of an examination subject are acquired, and in which a multi-dimensional data field representing the examination subject is reconstructed from said plurality of exposures, said programming instructions causing said computer to:
receive said plurality of exposures to a computerized processor;
contemporaneously with reconstruction of said multi-dimensional data field, automatically analyze said plurality of exposures to determine the quality information that indicates a reliability of said multi-dimensional data field for each of a plurality of picture elements in said data field; and
make said quality information available at an output for viewing by a viewer contemporaneously with viewing the reconstructed multi-dimensional field.

17. A device to provide spatially resolved quality information for an x-ray imaging procedure in which a multi-dimensional data field representing an examination subject is reconstructed from a plurality of x-ray exposures of the examination subject, said device comprising:
a computerized processor having an input at which said plurality of exposures are provided to the computerized processor;
said computerized processor being configured to automatically analyze. contemporaneously with reconstruction of said multi-dimensional data field, said plurality of exposures to determine the quality information that indicates a reliability of said multi-dimensional data field for each of a plurality of picture elements in said data field; and
said computerized processor being configured to make said quality information available at an output of said computerized processor for viewing by a viewer contemporaneously with viewing the reconstructed multi-dimensional field.

18. A device as claimed in claim 17 wherein:
said computerized processor said computerized processor is configured to segment each exposure of said plurality of exposures to identify an exposure region in each exposure in which a projection line ends that has traversed a partial volume of the examination subject having a predetermined property associated with acquisition of the exposures; and
said computerized processor is configured to determine said quality information by identifying, for each picture element in said plurality of picture elements, that picture element was imaged in the respective exposure regions of the plurality of exposures.

19. A device as claimed in claim 17 wherein said computerized processor is configured to display said multi-dimensional data field that is reconstructed from said plurality of exposures in a display presentation that is generated by said computerized processor dependent on said quality information.

20. A computed tomography system comprising:
a data acquisition device that acquires a plurality of exposures of an examination subject, said data acquisition device comprising a radiation detector selected from the group consisting of line detectors and area detectors;
an image reconstruction computer that is supplied with said plurality of exposures and that is configured to reconstruct a multi-dimensional data field representing the examination subject from said plurality of exposures;
a computerized processor having an input at which said plurality of exposures are provided to the computerized processor;
said computerized processor being configured to automatically analyze. contemporaneously with reconstruction of said multi-dimensional data field, said plurality of exposures to determine the quality information that indicates a reliability of said multi-dimensional data field for each of a plurality of picture elements in said data field; and
said computerized processor being configured to make said quality information available at an output of said computerized processor for viewing by a viewer contemporaneously with viewing the reconstructed multi-dimensional field.
